(19) United States
(12) Patent Application Publication
(10) Pub. No.: US 2021/0271033 A1
(43) Pub. Date: Sep. 2, 2021

(54) FIBER OPTIC CABLE ASSEMBLIES AND METHODS OF FORMING THE SAME

(71) Applicant: CORNING OPTICAL FIBER CABLE (CHENGDU) CO., LTD., Chengdu (CN)

(72) Inventors: Songhua Cao, Shanghai (CN); Hong Feng Guo, Shanghai (CN); Shun Sheng Zhou, Shanghai (CN)

(21) Appl. No.: 17/325,372

(22) Filed: May 20, 2021

Related U.S. Application Data
(63) Continuation of application No. PCT/CN2018/118529, filed on Nov. 30, 2018.

(51) Int. Cl. G02B 6/38

(52) U.S. Cl. CPC G02B 6/3889; G02B 6/3865

(57) ABSTRACT

Fiber optic cable assemblies are provided that comprise a fiber optic cable, a fiber optic connector installed on at least one of the fiber optic cable, and a boot that is molded over portions of the fiber optic connector and fiber optic cable. A tube is used to prevent material of the boot from entering space that exists between a connector body of the fiber optic connector and an end of a jacket of the fiber optic cable. Methods of forming the fiber optic cable assemblies are also disclosed.

### PRIORITY APPLICATION

This application is a continuation of International Application No. PCT/CN2018/118529, filed on Nov. 30, 2018, the content of which is relied upon and incorporated herein by reference in its entirety.

### BACKGROUND

This disclosure relates generally to optical connectivity, and more particularly to fiber optic cable assemblies that include over-molded strain boots (i.e., strain-relief members).

Optical fibers are useful in a wide variety of applications, including the telecommunications industry for voice, video, and data transmissions. In a telecommunications system that uses optical fibers, there are typically many locations where fiber optic cables that carry the optical fibers connect to equipment or other fiber optic cables. To conveniently provide these connections, fiber optic connectors are often provided on the ends of fiber optic cables. The process of terminating individual optical fibers from a fiber optic cable is referred to as “connectorization.” Connectorization can be done in a factory, resulting in a “pre-connectorized” or “pre-terminated” fiber optic cable, or the field (e.g., using a “field-installable” fiber optic connector).

Regardless of where installation occurs, a fiber optic connector typically includes a ferrule with one or more bores that receive one or more optical fibers. The ferrule supports and positions the optical fiber(s) with respect to a housing of the fiber optic connector. Thus, when the housing of the fiber optic connector is mated with another connector (e.g., in an adapter), an optical fiber in the ferrule is positioned in a known, fixed location relative to the housing. This allows an optical connection to be established when the optical fiber is aligned with another optical fiber provided in the mating connector.

The housing or body components of a fiber optic connector are often relatively rigid so that the fiber optic connector can withstand a variety of forces during handling and use without affecting the optical connection that may be or has been established. Having rigid components, however, presents design challenges elsewhere. For example, fiber optic cables upon which fiber optic connectors are installed are typically much less rigid than connector bodies. The rapid transition from high stiffness to low stiffness may result in stress concentrations where the cable meets the connector body. Radial loads applied to the cable may then result in the cable bending (e.g., where the stresses are concentrated) beyond a minimum bend radius that must not be exceeded for the cable to function properly.

To address the above-mentioned challenges, a fiber optic connector typically includes a flexible, strain-relieving boot that snaps onto the connector body and extends rearwardly over a portion of the cable. The boot provides a transition in stiffness between the fiber optic connector and the cable. Although many different boot designs have been proposed to properly provide this transition, new solutions are still desired.

### SUMMARY

Embodiments of fiber optic assemblies are provided in this disclosure. According to one embodiment, a fiber optic assembly comprises a fiber optic cable having at least one optical fiber, a cable jacket surrounding the at least one optical fiber, and aramid fibers between the cable jacket and the at least one optical fiber. The fiber optic cable assembly also includes a fiber optic connector installed on an end of the fiber optic cable. The fiber optic connector includes a connector body that has a back-end portion. The at least one optical fiber extends through the back-end portion of the connector body. The cable jacket includes a jacket end portion defining an end of the cable jacket that is spaced from the back-end portion of the connector body. At least some of the aramid fibers extend beyond the end of the cable jacket and over the back-end portion of the connector body. The fiber optic connector also includes a tube having a first portion positioned over the back-end portion of the connector body and a second portion positioned over the jacket end portion. At least some of the aramid fibers extend between the first portion of the tube and the back-end portion of the connector body. The fiber optic connector also includes a boot molded over the back-end portion of the connector body and the jacket end portion such that the boot is also molded over the tube. The tube is configured to prevent material of the boot from entering space between the end of the cable jacket and the back-end portion of the connector body.

According to one aspect or embodiment, the first portion of the tube is not deformed. There is no crimping of the tube, for example.

According to another aspect or embodiment, there is no heat shrink tube over the jacket end portion of the cable jacket or the tube.

According to another aspect or embodiment, the first portion of the tube is cylindrical. The second portion of the tube may also be cylindrical in some embodiments. And furthermore, the first portion of the tube may be larger than the second portion of the tube. For example, the first portion of the tube have a first outer diameter, and the second portion of the tube may have a second outer diameter that is less than the first outer diameter.

According to another aspect or embodiment, the boot conforms to the tube such that the boot contacts at least 95% of an exterior of the tube.

According to another aspect or embodiment, at least some of the aramid fibers have respective end portions extending beyond the first portion of the tube and at least partially encapsulated by the material of the boot.

According to another aspect or embodiment the material of the boot comprises a polyamide thermoplastic material. The tube may comprise a different material, such as metal.

In some embodiments, the at least one optical fiber consists of a single optical fiber, the fiber optic connector further includes a ferrule that is biased relative to the connector body, and the single optical fiber is secured to ferrule. In other embodiments, the at least one optical fiber comprises first and second optical fibers, wherein: the fiber optic connector further comprises first and second connector sub-assemblies supported by the connector body; each of the first and second connector sub-assemblies includes a connector housing and a ferrule supported within the connector housing; the first optical fiber is secured to the ferrule of the first connector sub-assembly; and the second optical fiber is secured to the ferrule of the second connector sub-assembly.

Methods of forming a fiber optic cable assembly are also provided in this disclosure, wherein the fiber optic cable assembly is formed from a fiber optic cable that includes at least one optical fiber, a cable jacket surrounding the at least one optical fiber, and aramid fibers between the cable jacket and the at least one optical fiber. According to one embodiment, a method comprises: positioning a tube on the cable jacket; removing some of the cable jacket so that a length of the at least one optical fiber and at least some of the aramid fibers extend beyond an end of the cable jacket; positioning a connector body on the length of the at least one optical fiber, wherein the connector body includes a back-end portion through which the at least one optical fiber extends, and wherein the connector body is positioned on the length of the at least one optical fiber so that the back-end portion is spaced from the end of the cable jacket; moving the tube along the cable so that a first portion of the tube is positioned over the back-end portion of the connector body and a second portion of the tube is positioned over a jacket end portion that defines the end of the cable jacket, wherein the at least some of the aramid fibers extend between the first portion of the tube and the back-end portion of the connector body; and molding a boot over the back-end portion of the connector body and the jacket end portion of the cable jacket such that the boot is also molded over the tube. The tube prevents material of the boot from entering space between the end of the cable jacket and the back-end portion of the connector body.

According to a further aspect or embodiment, the method further comprises: placing the back-end portion of the connector body, the tube, and a portion of the fiber optic cable within a cavity of a mold; flowing the material of the boot into the cavity of the mold, wherein the material is kept at a temperature below 240° C. and at a pressure less than 4000 kPa; solidifying the material to form the boot within the mold; and removing the portion of the fiber optic cable, the back-end portion of the connector body, and the boot from the mold.

Additional features and advantages will be set out in the detailed description which follows, and in part will be readily apparent to those skilled in the technical field of optical connectivity. It is to be understood that the foregoing general description, the following detailed description, and the accompanying drawings are merely exemplary and intended to provide an overview or framework to understand the nature and character of the claims.

### BRIEF DESCRIPTION OF THE DRAWINGS

The accompanying drawings are included to provide a further understanding, and are incorporated in and constitute a part of this specification. The drawings illustrate one or more embodiment(s), and together with the description serve to explain principles and operation of the various embodiments. Features and attributes associated with any of the embodiments shown or described may be applied to other embodiments shown, described, or appreciated based on this disclosure.

FIG. 1 is a perspective view of an example of a simplex fiber optic connector including a ferrule configured to support a single optical fiber.

FIG. 2 is a perspective view of an example of a duplex fiber optic connector that includes two connectors according to FIG. 1 as sub-assemblies.

FIG. 3 a perspective view of an end of a fiber optic cable being prepared to form a fiber optic cable assembly according to this disclosure.

FIG. 4 is a perspective view similar to FIG. 3, but shows a connector body being positioned on the end of the fiber optic cable.

FIG. 5 is a perspective view similar to FIG. 4, but shows the tube moved along the cable to extend over a back-end portion of the connector body and an end of a cable jacket.

FIGS. 6A and 6B are top elevation views of respective first and second mold components used to form a boot over portions of

FIG. 7 is a perspective view of the first and second mold components assembled together, and with the back-end portion of the connector body within a cavity of the mold.

FIG. 8 is a side view of a portion of a fiber optic cable assembly according to this disclosure, wherein the fiber optic cable assembly includes a boot that has been molded over the back-end portion of the connector body and a jacket end portion of the cable jacket.

FIG. 9 is a cross-sectional view of the portion of the fiber optic cable assembly shown in FIG. 8.

### DETAILED DESCRIPTION

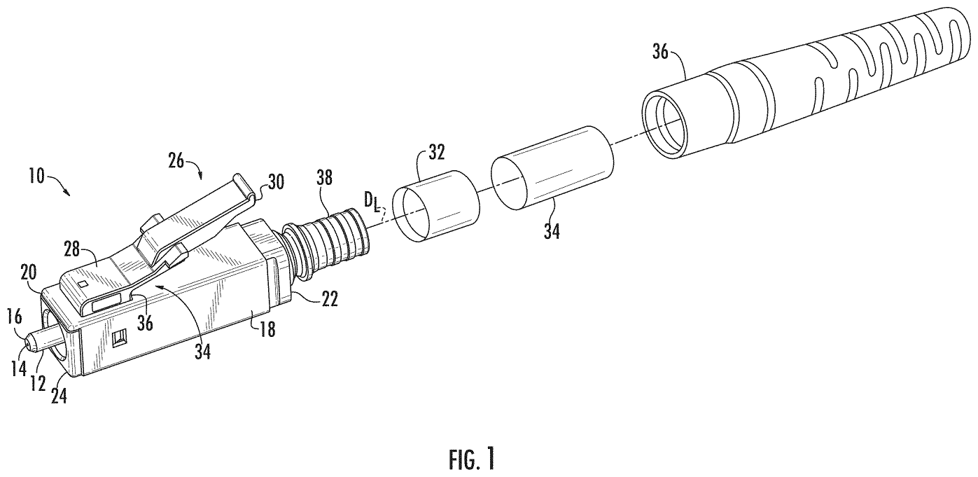

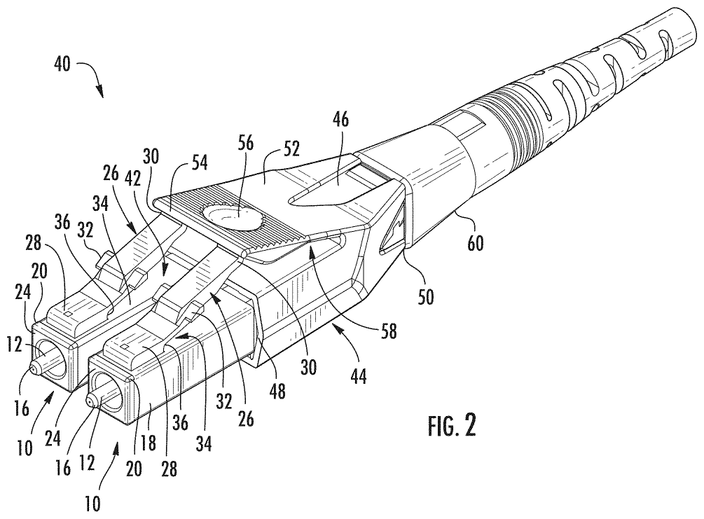

Various embodiments will be further clarified by examples in the description below. In general, the description relates to fiber optic cable assemblies having over-molded connector boots. In other words, the description relates to fiber optic cables assembled with fiber optic connectors (thereby forming fiber optic cable assemblies), with at some of the connectors having a boot molded over a region where the cable joins to another component of the connector. The connector may otherwise have a conventional design, like the examples shown in FIGS. 1 and 2. FIG. 1 illustrates a fiber optic connector 10 (“connector 10”) in the form of a simplex LC connector (e.g., according to IEC standard 61754-20:2012), and FIG. 2 illustrates a fiber optic connector (“connector 40”) in the form of a duplex LC connector (e.g., also according to IEC 61754-20:2012). The connectors 10, 40 will first be described to provide context for the principles of this disclosure, which may be applied to these or other connector designs.

As shown in FIG. 1, the connector 10 includes a ferrule 12 configured to support an optical fiber (not shown) extending in a generally longitudinal direction D_{L} through a bore 14 of the ferrule 12. An intermediate portion of the ferrule 12 extends through a cap 24 coupled to a connector body 18 (also referred to as a “connector sub-assembly body 18,” “connector housing 18,” or simply “housing 18”). The ferrule 12 extends from a ferrule holder (not shown) that is retained within the connector body 18 by the cap 24. A spring (not shown) biases the ferrule holder forward within the connector body 18 so that a front end 16 of the ferrule 12 projects forward beyond a front end 20 of the connector body 18. The front end 16 of the ferrule 12 presents the optical fiber extending through the bore 14 for optical coupling with a mating component (e.g., another fiber optic connector).

The connector 10 further includes a latch arm 26 extending outwardly and rearwardly from (e.g., in a slanted direction relative to) a portion of the connector body 18. In this regard, the latch arm 26 has a proximal end 28 coupled to the connector body 18 and a distal end 30 spaced from the connector body 18, with the connector body 18 and the latch arm 26 being separated from one another and defining a space therebetween. An intermediate portion of the latch arm 26 includes cantilever latch tabs, which protrude laterally from the latch arm 26. The distal end 30 of the latch arm 26 may be depressed toward the connector body 18 to disengage the connector 10 from another structure, such as an adapter or a dust cap (neither shown in FIG. 1).

Normally a crimp ring or band 32, a heat shrink tube 34, and elastomeric boot 36 are provided with the connector 10; they are installed at the time of installing other components of the connector 10 onto a cable (not shown in FIG. 1). The crimp ring 32 is typically a metal component that is crimped (i.e., deformed) onto a back-end portion 38 of the connector body 18 to secure the cable to the connector 10. Specifically, cables may include strength elements in the form of aramid yarns or fibers, and these aramid fibers may be extended over the rear portion 38 of the connector body 18. Placing the crimp ring 32 over this cable-connector interface and performing the crimping secures the aramid fibers to the connector body 18. The heat shrink tube 34 is then used to cover the interface between the crimp ring 32 and the portion of the cable from which the aramid fibers extend. Finally, the boot 36 is used to cover portions of both the connector 10 and cable to help limit bending at the cable-connector interface.

FIG. 2 is a perspective view of the duplex connector 40, which includes as sub-assemblies two of the simplex connectors 10 according to FIG. 1. For convenience, the term “connector sub-assemblies” (or “connector elements”) will be used to refer to the connectors 10 when discussing these elements in connection with the connector 40. Indeed, in alternative embodiments, duplex connectors may include connector elements that are not similar to simplex fiber optic connectors in all respects.

Still referring to FIG. 2, proximal portions of the connector sub-assemblies 10 in the connector 40 are separated by a lateral gap 42. Rear portions of each connector sub-assembly 10 are received within a shell 44 that surrounds a common connector body or internal housing 46 that supports each connector sub-assembly 10. The shell 44 includes a front end 48 defining a generally rectangular opening that receives rear portions of the connector sub-assemblies 10. The shell 44 also includes a rear end 50 having a narrowed width in comparison to the front end 48. An outer boot 60 is arranged proximate to the rear end 50 of the shell 44, and may be fitted over a portion of the connector body 46. A trigger 52 extends outwardly and forwardly (e.g., in a slanted direction relative to) the shell 44 above a recess 58, with a front end 54 of the trigger 52 extending over distal ends 30 of the latch arms 26 of the connector sub-assemblies 10. In operation, a user may press the trigger 52 (e.g., at a finger receiving area 56) in a direction toward the shell 44 to cause the distal ends 30 of the latch arms 26 to move toward the respective connector bodies 18, thereby operating the latch arms 26 to permit disengagement of the connector sub-assemblies 10 from another structure, such as an adapter or a dust cap (neither shown in FIG. 2).

Having described the connector 10 shown in FIG. 1 and the connector 40 shown in FIG. 2 for comparison purposes, fiber optic assemblies having over-molded connector boots will now be described. The fiber optic cable assemblies include a fiber optic connector with a connector body, such as the connector body 18 (e.g., when the fiber optic connector is a simplex connector) or the common connector body 46 (e.g., when the fiber optic connector is a duplex connector), but a different boot design than what is shown in FIGS. 1 and 2. For convenience, an example will be described using the connector body 46 and the new boot design. The example can be best understood from a description of how the cable assembly is formed.

Starting with FIG. 3, a fiber optic cable (“cable 70”) includes one or more optical fibers (represented by line 72), a cable jacket (“jacket 74”) surrounding the optical fiber(s) 72, and aramid fibers 76 (i.e., yarns) between the jacket 74 and the optical fiber(s) 72. FIG. 3 illustrates one end of the cable 70 after removing a portion of the jacket 74 to expose a length L of the optical fiber(s) 72 and aramid fibers 76. In other words, the jacket 74 may have an initial end (not shown) covering the length L, but then be cut or otherwise removed to expose the previously-covered length L of the optical fiber(s) 72 and aramid fibers 76. This results in the jacket 74 having a new end 78 (“end 78”), which is what is shown in FIG. 3.

FIG. 3 also illustrates a tube 80 positioned on an end portion 82 (“jacket end portion 82”) of the jacket 74 that defines the end 78. The tube 80 may be placed on the cable 70 before or after cutting the jacket 74 to expose the optical fiber(s) 72 and aramid fibers 76. In the embodiment shown, the tube 80 includes a cylindrical first portion 84 that defines a front end 86 of the tube 80, a smaller cylindrical second portion 88 that defines a back end 90 of the tube 80, and a transition region 92 between the first and second portions 84, 88. The first portion 84 has an inner diameter larger than an outer diameter of the jacket 74 such that a gap exists between an inner surface of the tube 80 in the first portion 84 and an outer surface 94 of the jacket 74. The second portion 88 has an inner diameter that is slightly smaller than or approximately equal to the outer diameter of the jacket 74. For example, there may be a slight interference between the second portion 88 of the tube 80 and the jacket 74, with the inner surface of the tube 80 in the second portion 88 contacting the outer surface 94 of the jacket 74. If there is slight interference, the forces are such that the tube 80 can still be easily moved (e.g., slid) along the jacket 74. The tube 80 may be constructed from metal or another suitable material.

FIG. 4 illustrates the connector body 46 positioned on the end of the cable 70. To do so, the connector body 46 is moved over the optical fiber(s) 72 (not shown in FIG. 4) such that the optical fiber(s) 72 extend through at least a back-end portion 96 (FIG. 9) of the connector body 46. The aramid fibers 76 have been cut to a shorter length compared to FIG. 3 and positioned over the back-end portion 96 of the connector body 46. The back-end portion 96 remains spaced from the end 78 of the jacket 74 so that the aramid fibers 76 can extend out of the jacket 74 and over the back-end portion 96.

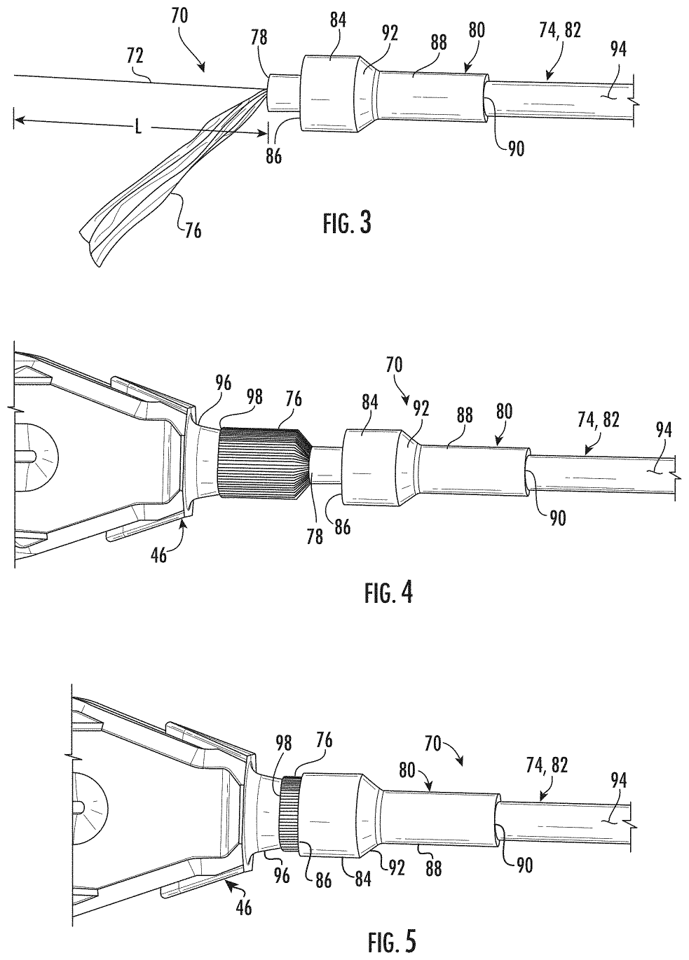

As shown in FIG. 5, the tube 80 may then be moved along the cable 70 until the first portion 84 is positioned over the back-end portion 96 of the connector body 46. This results in portions of the aramid fibers 76 extending between the first portion 84 of the tube 80 and the back-end portion 96 of the connector body 46. Although the aramid fibers 76 are accommodated in such a manner, space between the first portion 84 of the tube 80 and the back-end portion 96 of the connector body 46 is minimal. For example, the first portion 84 of the tube 80 may have an inner diameter that is within 10% of an outer diameter of the back-end portion 96. Respective ends 98 of the aramid fibers 76 may remain outside of the tube 80 (i.e., uncovered).

Still referring to FIG. 5, the second end portion 88 of the tube 80 does not move off the jacket end portion 82. That is, at least some of the second portion 88 remains positioned over the jacket end portion 82. Thus, the tube 80 covers the space between the back-end portion 96 of the connector body 46 and the end 78 of the jacket 74.

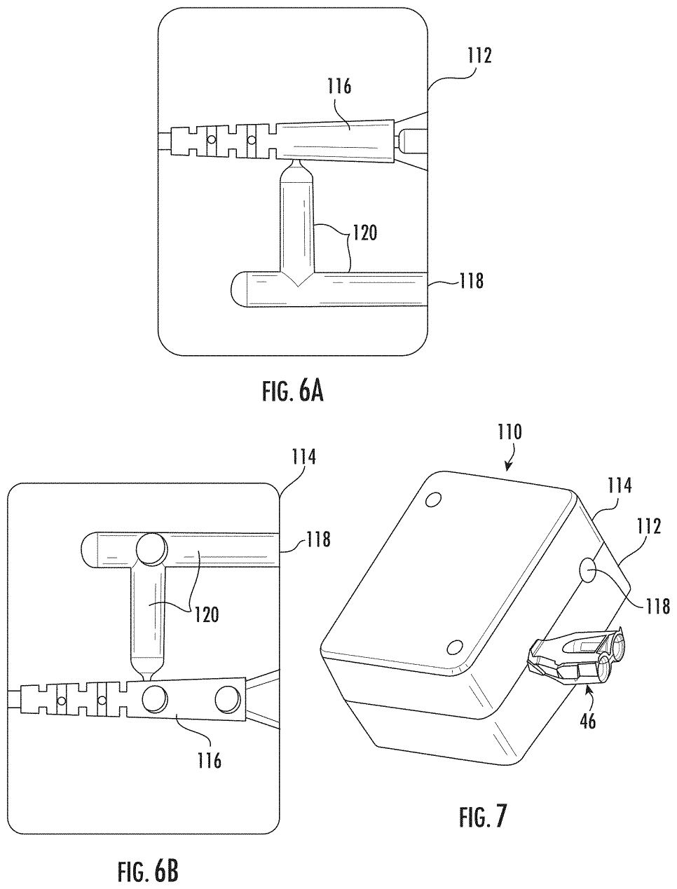

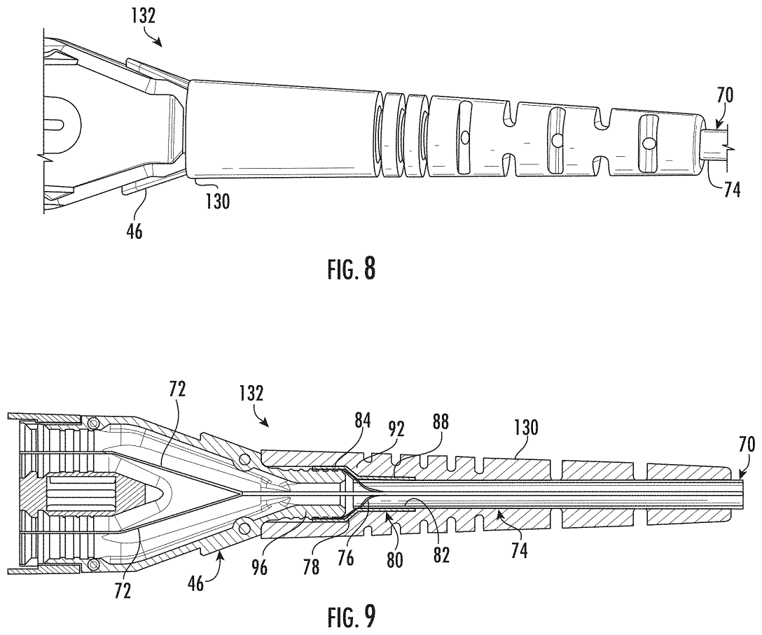

FIGS. 6A and 6B illustrate examples of respective first and second mold components 112, 114, and FIG. 7 illustrates the first and second mold components 112, 114 assembled together to define a mold 110. The cable 70 with the connector 40 partially assembled in the manner described above may be placed into a cavity 116 of the mold 110. As can be appreciated from FIG. 7, the back-end portion 96 of the connector body 46 may be received in the cavity 116, and a remainder of the connector body 46 may remain outside the cavity 116 on one side of the mold 110. The cable 70 (not shown in FIG. 7) extends out of the cavity 116 on an opposite side of the mold 110. Thus, the back-end portion 96 of the connector body 46, the jacket end portion 82, and the tube 80 that is positioned over the back-end portion 88 and jacket end portion 82 are positioned in the cavity 116. Molding material may be introduced into the cavity 116 through an injection port 118 and injection channels 120 defined by the first and second mold components 112, 114. Additional details relating to the molding material and process will be described in further detail below.

Although the molding material may be flowable when being introduced into the cavity 116, the tube 80 prevents the molding material from entering into the connector body 46 and jacket 74. For example, this may be due to the close-fitting arrangement between: a) the first portion 84 of the tube 80 and the back-end portion 96 of the connector body 46, and b) the second portion 88 of the tube 80 and the jacket end portion 82. The ends 98 of the aramid fibers 76 that remained exposed (see FIG. 5) may be at least partially encapsulated by the molding material.

Ultimately the molding material fully occupies the cavity 116 and is brought into a non-flowable state, such as by allowing to cool or by actively cooling. As shown in FIGS. 9 and 10, which illustrate the cable 70 removed from the mold, this results in the molding material forming a boot 130 that has the shape of the cavity 116. The cable 70 together with the connector 40 (including the boot 130) form a cable assembly 132. The boot 130 conforms to the shape of the components it covers. Material of the boot 130, for example, may be in contact with substantially all (e.g., at least 95%) of an exterior of the tube 80 and adjacent portions of the connector body 18 and jacket 74. Thus, unlike the boots 36, 60 (FIG. 1), the cable assembly 132 does not include a heat shrink tube (e.g., the heat shrink tube 34 in FIG. 1) over the cable-connector interface. The material costs and processing steps associated with applying such heat shrink tubes (e.g., using ovens or other devices to apply heat) can be avoided.

The same can be said with respect to the crimp ring 32 (FIG. 1). That is, the cable assembly 132 avoids the need to perform a crimping step; there is no need to deform the tube 80 or any other component onto the back-end portion 96 of the connector body 46 to secure the aramid fibers 76 to the connector 40. Avoiding this step in forming the cable assembly 132 may not only save time and cost (e.g., by not needing a crimping tool), but may also avoid potential damage to the connector body 46.

As can be appreciated, although the molding step may be needed to form the cable assembly 132, multiple steps that are traditionally required can be avoided. Manufacturing process flows can be streamlined, and the total amount of equipment needed for forming the cable assembly can be reduced.

Advantageously, the molding may be performed using thermoplastic materials having properties suitable for low pressure molding (LPM). This type of molding may be characterized by relatively low pressures and temperatures. For example, the material of the boot 130 may be kept at a temperature below 240° C. and at a pressure less than 4000 kPa during the molding process. Molding may be performed relatively fast, with the boot 130 being formed in less than 60 seconds, or even in less than 30 seconds in some embodiments.

Examples of thermoplastic materials that may be suitable for low pressure molding include polyamide-based materials, such as TECHNOMELT® PA 6208, 6790, 633, 641, 652, or 673 (Henkel Corp., Dusseldorf, Germany). These materials have viscosities in the range of about 3000 mPa:s to about 7000 mPa:s at 210° C., glass transition temperatures of no greater than −35° C., and service temperatures that range from no less than about −40° C. to no greater than about 140° C. A glass transition temperature is the point at which a material goes from a hard brittle state to a flexible or soft rubbery state as temperature is increased. A common method for determining glass transition temperature uses the energy release on heating in differential scanning calorimetry. In certain embodiments, service temperature of a thermoplastic material may be determined by compliance with one or more industry standards for telecommunication fiber reliability testing, such as (but not limited to): ITU-T G.652, IEC 60793-2, Telcordia GR-20-CORE, and TIA/EIA-492.

Those skilled in the art will appreciate that modifications and variations can be made without departing from the spirit or scope of the invention. For example, although LC connectors are described above and shown in the drawings, the same principles may be applied to other connector designs, such as SC connectors (e.g., according to IEC 61754-4:2013) and MPO connectors (e.g., according to IEC 61754-7:2014). Similarly, the mold 110 should be seen merely as an example, as noted above. Different mold designs may be used to form the boot 130 by applying the principles of this disclosure. This includes embodiments of molds having multiple cavities (e.g., 12 or more) for forming multiple boots simultaneously, thereby increasing manufacturing capacity/overall throughput.

Since modifications, combinations, sub-combinations, and variations of the disclosed embodiments incorporating the spirit and substance of the invention may occur to persons skilled in the art, the invention should be construed to include everything within the scope of the appended claims and their equivalents.

What is claimed is:

1. A fiber optic cable assembly, comprising:
a fiber optic cable having at least one optical fiber, a cable jacket surrounding the at least one optical fiber, and aramid fibers between the cable jacket and the at least one optical fiber; and
a fiber optic connector installed on an end of the fiber optic cable, the fiber optic connector including:
a connector body having a back-end portion, wherein the at least one optical fiber extends through the back-end portion of the connector body;
the cable jacket includes a jacket end portion defining an end of the cable jacket that is spaced from the back-end portion of the connector body; and
at least some of the aramid fibers extend beyond the end of the cable jacket and over the back-end portion of the connector body;
a tube having a first portion positioned over the back-end portion of the connector body and a second portion positioned over the jacket end portion of the cable jacket, wherein the at least some of the aramid fibers extend between the first portion of the tube and the back-end portion of the connector body; and
a boot molded over the back-end portion of the connector body and the jacket end portion of the cable jacket such that the boot is also molded over the tube, wherein the tube is configured to prevent material of the boot from entering into space between the end of the cable jacket and the back-end portion of the connector body.

2. The fiber optic cable assembly of claim 1, wherein the first portion of the tube is not crimped onto the back-end portion of the connector body.

3. The first optic cable assembly of claim 2, wherein the first portion of the tube is cylindrical.

4. The fiber optic cable assembly of claim 3, wherein the second portion of the tube is cylindrical.

5. The fiber optic cable assembly of claim 4, wherein the first portion of the tube has a first inner diameter and the second portion of the tube has a second inner diameter that is less than the first outer diameter.

6. The fiber optic cable assembly of claim 5, wherein the boot conforms to the tube such that the boot contacts at least 95% of an exterior of the tube.

7. The fiber optic cable assembly of claim 1, wherein the at least some of the aramid fibers have respective end portions extending beyond the first portion of the tube and at least partially encapsulated by the material of the boot.

8. The fiber optic cable assembly of claim 1, wherein the boot comprises a polyamide thermoplastic material.

9. The fiber optic cable assembly of claim 8, wherein the tube comprises metal.

10. The fiber optic cable assembly of claim 1, wherein there is no heat shrink tube over the end portion of the cable jacket.

11. The fiber optic cable assembly of claim 1, wherein the at least one optical fiber consists of a single optical fiber, the fiber optic connector further includes a ferrule that is biased relative to the connector body, and the single optical fiber is secured to ferrule.

12. The fiber optic cable assembly of claim 1, wherein:
the at least one optical fiber comprises first and second optical fibers;
the fiber optic connector further comprises first and second connector sub-assemblies supported by the connector body;
each of the first and second connector sub-assemblies includes a connector housing and a ferrule supported within the connector housing;
the first optical fiber is secured to the ferrule of the first connector sub-assembly; and
the second optical fiber is secured to the ferrule of the second connector sub-assembly.

13. A method of forming a fiber optic cable assembly from a fiber optic cable that includes at least one optical fiber, a cable jacket surrounding the at least one optical fiber, and aramid fibers between the cable jacket and the at least one optical fiber, the method comprising:
positioning a tube on the cable jacket;
removing some of the cable jacket so that a length of the at least one optical fiber and at least some of the aramid fibers extend beyond an end of the cable jacket;
positioning a connector body on the length of the at least one optical fiber, wherein the connector body includes a back-end portion through which the at least one optical fiber extends, and wherein the connector body is positioned on the length of the at least one optical fiber so that the back-end portion is spaced from the end of the cable jacket;
moving the tube along the cable so that a first portion of the tube is positioned over the back-end portion of the connector body and a second portion of the tube is positioned over a jacket end portion that defines the end of the cable jacket, wherein the at least some of the aramid fibers extend between the first portion of the tube and the back-end portion of the connector body; and
molding a boot over the back-end portion of the connector body and the jacket end portion of the cable jacket such that the boot is also molded over the tube, wherein the tube prevents material of the boot from entering space between the end of the cable jacket and the back-end portion of the connector body.

14. The method of claim 13, wherein the tube is positioned on the cable jacket before the removing of some of the cable jacket.

15. The method of claim 13, wherein the removing of some of the cable jacket results in the at least some of the aramid fibers extending beyond the end of the cable jacket an initial length, the method further comprising cutting the at least some of the aramid fibers.

16. The method of claim 13, wherein the first portion of the tube is not deformed onto the back-end portion of the connector body before the molding of the boot.

17. The method of claim 13, wherein the at least some of the aramid fibers have respective end portions extending beyond the first portion of the tube after the first portion of the tube is positioned over the back-end portion of the connector body, and wherein the molding of the boot further comprises at least partially encapsulating the end portions of the at least some of the aramid fibers with the material of the boot.

18. The method of claim 13, wherein the molding of the boot further comprises:
placing the back-end portion of the connector body, the tube, and a portion of the fiber optic cable within a cavity of a mold;
flowing the material of the boot into the cavity of the mold, wherein the material is kept at a temperature below 240° C. and at a pressure less than 4000 kPa;
solidifying the material to form the boot within the mold; and
removing the portion of the fiber optic cable, the back-end portion of the connector body, and the boot from the mold.

19. The method of claim 13, wherein the molding of the boot is performed in less than 60 seconds.

20. The method of claim 13, wherein the molding of the boot is performed in less than 30 seconds.
